(19) United States
(12) Patent Application Publication
(10) Pub. No.: US 2025/0222723 A1
(43) Pub. Date: Jul. 10, 2025

(54) TIRE SUITABLE FOR RUNNING FLAT AND COMPRISING A CORRUGATED CROWN LAYER

(71) Applicant: COMPAGNIE GENERALE DES ETABLISSEMENTS MICHELIN, Clermont-Ferrand (FR)

(72) Inventors: WALTER LEE WILLARD, Clermont-Ferrand (FR); BENJAMIN VILPERT, Clermont-Ferrand (FR); PATRICE FRAYSSE, Clermont-Ferrand (FR); FRANCOIS-XAVIER BRUNEAU, Clermont-Ferrand (FR)

(21) Appl. No.: 18/854,896

(22) PCT Filed: Mar. 6, 2023
(86) PCT No.: PCT/EP2023/055617

§ 371 Date: Oct. 7, 2024

(30) Foreign Application Priority Data
Apr. 8, 2022 (FR) 2203232

(51) Int. Cl. B60C 9/26; B60C 9/18; B60C 17/00

(52) U.S. Cl. CPC B60C 9/26; B60C 17/0009; B60C 2009/1828; B60C 2017/0063; B60C 2017/0072

(57) ABSTRACT

A tire (10) comprises a crown block (12), two beads (32), and two sidewalls (30) connecting each bead (32) to the crown block (12). The crown block (12) comprises a crown reinforcement (16) comprising a corrugated crown layer (24, 26, 28) comprising corrugations. The tire (10) comprises a sidewall insert (90) comprising a rigid elastomeric composition (92, 93, 94) of which the radially exterior end (96) is arranged: radially to the outside of the equator (E) of the tyre, and axially to the inside of the axial end (241, 242) of the radially innermost crown layer (24) of the crown reinforcement (16) and at an axial distance ENG≤20 mm from the axial end (242).

The present invention relates to a tyre. The term “tyre” is understood to mean a tyre casing intended to form a cavity by cooperating with a support element, for example a rim, this cavity being capable of being pressurized to a pressure greater than atmospheric pressure. A tyre according to the invention has a structure of substantially toroidal shape of revolution about a main axis of the tyre.

Tyres comprising a crown block, two beads and two sidewalls connecting each bead to the crown block are known from WO2014057082, WO2014184158 or else WO2019086785. The crown block comprises a tread and a crown reinforcement arranged radially to the inside of the tread. The tyre comprises a sidewall insert arranged axially between the exterior surface of said sidewall and the interior surface of said sidewall. Each sidewall insert comprises a rigid elastomeric composition having a relatively high modulus at 10% extension, that is to say one greater than or equal to 4 MPa. Each sidewall insert has the function of allowing the tyre to run flat.

A tyre comprising such a sidewall insert is suitable for running flat and is therefore suitable for running when the pressure of the internal cavity of the tyre is equal to atmospheric pressure (by misuse of language, it is often said that the pressure is zero whereas it is the overpressure with respect to atmospheric pressure that is zero). A tyre suitable for run-flat use comprises self-supporting sidewalls, which is to say ones capable, in the presence of a pressure equal to atmospheric pressure, of bearing the same load, for example, the rated load as indicated in the manual of the European Tyre and Rim Technical Organisation (ETRTO) 2021 standard, which the tyre is capable of bearing when inflated to its usual inflation pressure, for example, its nominal inflation pressure as indicated in the ETRTO Standards Manual, 2021, over a distance greater than or equal to a certain threshold distance at a speed greater than or equal to 80 km/h. Thus, a tyre suitable for run-flat use is such that, under its rated load as indicated in the ETRTO Standards Manual, 2021 and under atmospheric pressure, the or each sidewall cannot bend on itself in such a way as to bring two distant portions of the tyre into contact with one another. A tyre suitable for running flat preferably has a specific marking indicating the ability of the tyre to run flat. Thus, for example, markings in the form of the following acronyms are used, without this list being exhaustive: “ZP” for “Zero Pressure”, “SST” for “Self Supporting Technology”, “SSR” for “Self Supporting Runflat tyre”, “RF” for “Run Flat”, “RFT” for “Run Flat Tyre”, “EXT” for “EXTended”, “ZP-SR” for “Zero Pressure Short Range” or “ZPS” for “Zero Pressure System”. Another specific marking indicating the ability of the tyre to run flat is the presence of the letter “F” in the tyre size. Thus, tyres with dimensions 225/40R18 or 225/40ZR18, if they are suitable for running flat, have the markings 225/40RF18 or 225/40ZRF18.

Each sidewall insert has a radially interior end arranged radially to the inside of the equator of the tyre and a radially exterior end arranged radially to the outside of the equator of the tyre. More precisely, the radially exterior end is arranged axially to the inside of the axial end of the radially innermost crown layer of the crown reinforcement and arranged at a relatively large axial distance from the axial end of said crown layer. In tyres known from the prior art, this axial distance is approximately equal to 25 mm.

Although these tyres allow run flat in the event of a loss of pressure, these tyres have reduced comfort when running inflated as well as a rolling resistance that leaves scope for improvement on account of the presence of the sidewall insert. On the other hand, the presence of the relatively rigid sidewall insert, in addition to the run-flat function, makes it possible to give the tyre relatively good handling, especially when cornering.

The object of the invention is to provide a tyre suitable for running flat, exhibiting an improved compromise between comfort, rolling resistance and handling.

To this end, the subject of the invention is a tyre comprising a crown block, two beads, two sidewalls connecting each bead to the crown block, the crown block comprising a tread and a crown reinforcement arranged radially to the inside of the tread, the tyre comprising a sidewall insert arranged axially between the exterior surface of one of the sidewalls and the interior surface of said sidewall, the sidewall insert comprising at least one elastomeric composition referred to as rigid, the or each rigid elastomeric composition of the sidewall insert having a modulus at 10% extension greater than or equal to 4 MPa, the crown reinforcement comprises a central part of axial width equal to 80% of the axial width of the crown reinforcement and axially centred on the median plane of the tyre, the crown reinforcement comprising at least one crown layer, referred to as corrugated, comprising reinforcing elements embedded in a polymeric matrix, said corrugated crown layer comprising, in the central part of the crown reinforcement, at least one corrugation, the or each corrugation of said corrugated crown layer comprising a top of said corrugated crown layer and first and second bottoms of said corrugated crown layer which are adjacent to said top and arranged so that:
said top is arranged axially between said first and second bottoms,
said top is arranged radially to the outside of each first and second bottom, the radially exterior end of the sidewall insert is arranged:
   radially to the outside of the equator of the tyre, and
   axially to the inside of the axial end of the radially innermost crown layer of the crown reinforcement and at an axial distance ENG≤20 mm from said axial end.

According to the invention and as described in the preamble, the tyre is adapted for running flat.

The inventors behind the invention have discovered that varying the axial distance ENG between the radially exterior end of the sidewall insert and the axial end of the radially innermost crown layer made it possible to reduce or increase comfort, rolling resistance and handling. In particular, they discovered that the smaller the axial distance ENG, the more comfort is improved as a result of the elimination of part of the thickness of the relatively rigid sidewall insert arranged in the crown block. Similarly, the smaller the axial distance ENG, the more the rolling resistance is lowered as a result of the lower hysteresis losses due to the elimination of part of the thickness of the sidewall insert. Nevertheless, the smaller the axial distance ENG, the more flexible the crown block of the tyre becomes and the handling of the vehicle is worsened. They also discovered that the greater the axial distance ENG, the better the handling of the vehicle. However, because of the thickness of the sidewall insert arranged in the crown block, the greater the axial distance ENG, the more comfort is worsened as a result of the additional rigidity provided by the thickness of the sidewall insert arranged in the crown block. In addition, again because of the thickness of the sidewall insert located in the crown block, the greater the axial distance ENG, the more the rolling resistance is worsened as a result of the hysteresis losses due to the thickness of the sidewall insert arranged in the crown block.

Thus, it appeared to the inventors that an improved compromise between comfort, rolling resistance and handling was impossible to obtain by varying this axial distance ENG alone.

The inventors discovered that the right compromise could be achieved by using a crown reinforcement comprising at least one corrugated crown layer. Indeed, because of the corrugated crown layer, the crown block has very high lateral stiffness, vertical stiffness and cornering stiffness and, in any case, stiffness levels that are much higher than those of a similar tyre comprising substantially cylindrical crown layers without corrugations.

Thus, the inventors discovered that the combination of at least one corrugated crown layer and a relatively small axial distance ENG made it possible to achieve the desired improved compromise.

Obtaining this improved compromise is all the more surprising since, by using a corrugated crown layer, the inventors expected the handling of the tyre to become worse. Specifically, the sidewalls of the tyre form a flexible portion comprised between two rigid portions formed, on the one hand, by the crown reinforcement and, on the other hand, by each bead. On the one hand, because of its function as an interface with the support on which the tyre is mounted, for example a rim, each bead is rigid, in particular because of the materials of which it is made and because of its considerable thickness. Among these materials, mention will be made in particular of the reinforcing elements, generally made of metal, or else elastomeric compositions having high rigidity, for example moduli at 10% extension that are greater than 20 MPa. On the other hand, since the crown reinforcement has at least one corrugated crown layer, the crown reinforcement is also relatively more rigid, in any case stiffer than a crown reinforcement without a corrugated crown layer. Thus, in the case where a large force is exerted on the tyre, the rigid portions formed by the crown reinforcement and the beads transmit a relatively large proportion of this force to the least rigid part of the tyre, here each sidewall. Now, since each sidewall is arranged radially between each bead and the crown block, each sidewall bends with a relatively large amplitude, which is why worsened vehicle handling would be expected. Nevertheless, synergistically, the presence of the sidewall insert of relatively high rigidity makes it possible to reduce the amplitude of the bending of each sidewall in the case of a large force exerted on the tyre. Thus, handling is not worsened.

Concerning the modulus at 10% extension, commonly referred to as MA10, this is the elastic modulus of the compound measured during a uniaxial tensile test, at an elongation value of 0.1 (i.e. 10% elongation, expressed as a percentage). The uniaxial tension is applied to the test specimen at a constant rate, and the elongation and the force are measured. The measurement is carried out using a tensile testing machine of the “INSTRON” (registered trade mark) type, at a temperature of 23° C., and a relative humidity of 50% (standard ISO 23529). The conditions for measuring and using the results in order to determine the elongation and the stress are as described in the NF ISO 37:2012-03 standard. The stress is determined for an elongation of 0.1 and the modulus of elasticity under tension at 10% elongation is calculated by determining the ratio of this stress value to the elongation value. A person skilled in the art will know how to choose and adapt the dimensions of the test specimen according to the quantity of compound accessible and available in particular in the case of test specimens taken from the tyre.

The elastomeric composition of the sidewall insert is based on one or more elastomers. It may also comprise fillers and other components usually used in the field of compositions for tyres.

The interior surface delimits the interior cavity of the tyre. The interior cavity is intended to be pressurized by the inflation gas once the tyre has been mounted on a mounting support, for example a rim. The interior surface of the sidewall is therefore the part of the sidewall delimiting the interior cavity of the tyre.

The exterior surface is the surface of the tyre in contact with air at atmospheric pressure and visible from the outside of the tyre. The exterior surface of the sidewall is therefore the part of the sidewall in contact with air at atmospheric pressure and visible from the outside of the tyre.

In one embodiment, the or each sidewall insert comprises a rigid elastomeric composition. In some variants, the or each sidewall insert is made of a rigid elastomeric composition. In other variants, the or each sidewall insert comprises a rigid elastomeric composition and one or more elastomeric composition(s), referred to as flexible, of which the modulus at 10% extension is strictly less than 4 MPa.

In other embodiments, it may be envisaged that the or each sidewall insert comprises an assembly of several rigid elastomeric compositions. In some variants of these embodiments comprising an assembly of several rigid elastomeric compositions, all of the elastomeric compositions of the sidewall insert are rigid elastomeric compositions. In other variants of these embodiments comprising an assembly of several rigid elastomeric compositions, the sidewall insert comprises, in addition to the rigid elastomeric compositions, one or more elastomeric composition(s), referred to as flexible, of which the modulus at 10% extension is strictly less than 4 MPa.

In some embodiments, the radially exterior end is the radially exterior end of the rigid elastomeric composition of the insert or the radially outermost end of the radially exterior ends of the rigid elastomeric compositions of the insert assembly. In other embodiments, the radially exterior end is the outermost end of the radially exterior ends of the rigid or flexible elastomeric compositions of the insert.

Bottoms adjacent to a top will be understood to mean that no other bottom is arranged axially between the top and each adjacent bottom.

Apart from the fact that the or each corrugated crown layer describes a polygonal line comprising rectilinear segments in each meridian section plane, each corrugation comprises two points of inflection arranged axially between the top and each first and second bottom. A point of inflection means a point where, in a meridian section plane, the direction of curvature of the or each corrugated crown layer changes.

The axial width of the crown reinforcement is the width in the axial direction of the layer of the crown reinforcement having the greatest width in the axial direction. The width in the axial direction is the distance in the axial direction between the two axial ends of a layer. The or each layer of the crown reinforcement may be axially continuous or axially discontinuous between its two axial ends. Usually, the crown reinforcement of a passenger vehicle tyre comprises a hoop reinforcement and a working reinforcement arranged radially inside the hoop reinforcement, the hoop reinforcement being arranged radially between the tread and the working reinforcement, the hoop reinforcement comprising at least one hooping layer and the working reinforcement comprising at least one working layer.

The central part is axially centred on the median plane of the tyre, which means that each axial end of the central part is located at an axial distance from the median plane of the tyre equal to 40% of the axial width of the crown reinforcement.

The term “reinforcing element” is understood to mean an element providing mechanical reinforcement to the polymeric matrix in which this reinforcing element is intended to be embedded.

Preferably, each reinforcing element is filamentary, which means to say that each reinforcing element has a length at least 10 times greater than the largest dimension of its cross section, regardless of the shape of the latter: circular, elliptical, oblong, polygonal, in particular rectangular or square or oval. In the case of a rectangular cross section, the filamentary reinforcing element has the shape of a strip.

The matrix is said to be polymeric because it is based on a polymeric composition, this polymeric composition possibly comprising one or more polymers, for example selected from thermoplastic polymers, thermosetting polymers, elastomers, thermoplastic elastomers, and also fillers and other components usually used in the field of compositions for tyres, in particular compositions for embedding reinforcing elements.

The tyre according to the invention has a substantially toroidal shape about an axis of revolution substantially coinciding with the axis of rotation of the tyre. This axis of revolution defines three directions conventionally used by those skilled in the art: an axial direction, a circumferential direction and a radial direction.

The expression “axial direction” means the direction substantially parallel to the axis of revolution of the tyre, i.e. the axis of rotation of the tyre.

The expression “circumferential direction” means the direction that is substantially perpendicular both to the axial direction and to a radius of the tyre (in other words, tangent to a circle centred on the axis of rotation of the tyre).

The expression “radial direction” means the direction along a radius of the tyre, that is to say any direction that intersects the axis of rotation of the tyre and is substantially perpendicular to that axis.

The expression “median plane of the tyre” (denoted M) means the plane perpendicular to the axis of rotation of the tyre which is situated axially mid-way between the two beads and passes through the axial middle of the crown reinforcement.

The expression “equatorial circumferential surface” of the tyre means the combination of the planes passing, in each meridian section plane, through the equator (denoted E) of the tyre and perpendicular to the median plane and to the radial direction. The equator of the tyre is, in a meridian section plane (plane perpendicular to the circumferential direction and parallel to the radial and axial directions) the axis parallel to the axis of rotation of the tyre and situated equidistantly between the radially outermost point of the tread that is intended to be in contact with the ground and the radially innermost point of the tyre that is intended to be in contact with a support, for example a rim, the distance between these two points being equal to H.

The expression “meridian plane” means a plane parallel to and containing the axis of rotation of the tyre and perpendicular to the circumferential direction.

The expressions “radially inner/interior/inside” and “radially outer/exterior/outside” should be understood to mean closer to the axis of rotation of the tyre and further away from the axis of rotation of the tyre, respectively. The expressions “axially inner/interior/inside” and “axially outer/exterior/outside” should be understood to mean closer to the median plane of the tyre and further away from the median plane of the tyre, respectively.

The term “bead” means the portion of the tyre intended to allow the attachment of the tyre to a mounting support, for example a wheel comprising a rim. Thus, each bead is intended in particular to be in contact with a flange of the rim allowing it to be secured. Thus, the radially exterior end of the exterior surface of the bead of the tyre is defined as the radially outermost point on the exterior surface of the tyre in contact with a measuring rim of the tyre according to the ETRTO Standards Manual, 2021 when the tyre is inflated to its nominal pressure on this measuring rim.

Any range of values denoted by the expression “between a and b” indicates the range of values extending from more than a to less than b (i.e., endpoints a and b excluded), whereas any range of values denoted by the expression “from a to b” means the range of values extending from a up to b (i.e., including the strict endpoints a and b).

The tyres are, in certain preferred embodiments of the invention, intended for passenger vehicles as defined by the ETRTO Standards Manual, 2021. Such a tyre advantageously and optionally has a section in a meridian section plane characterized by a section height H and a nominal section width S within the meaning of the ETRTO Standards Manual, 2021, which are such that the ratio H/S, expressed as a percentage, is at most equal to 50 and preferably at most equal to 40 and is at least equal to 20, and the nominal section width S is at least equal to 205 mm and more preferably at least equal to 225 mm and at most equal to 385 mm. Furthermore, the diameter D at the flange, which defines the diameter of the rim on which the tyre is mounted, is at least equal to 16 inches and at most equal to 24 inches.

For any crown layer, a continuous surface, referred to as the radially exterior surface (SRE) of said layer, passing through the radially outermost point of each reinforcing element and a continuous surface, referred to as the radially interior surface (SRI) of said layer, passing through the radially innermost point of each reinforcing element, are defined. The radial distances between a layer of the crown reinforcement comprising reinforcing elements and any other point are measured from one or other of these surfaces and in such a way as not to incorporate the radial thickness of said layer. If the other measuring point is positioned radially to the outside of the reinforcing element layer, the radial distance is measured from the radially exterior surface SRE at that point. If the other measuring point is positioned radially to the inside of the reinforcing element layer, the radial distance is measured from the radially interior surface SRI at that point.

In preferred embodiments, the maximum radial amplitude of the or each corrugation is greater than or equal to 1.0 mm, preferably greater than or equal to 1.5 mm. In other preferred embodiments, the maximum radial amplitude of the or each corrugation is less than or equal to 3.0 mm, preferably less than or equal to 2.5 mm.

What is meant by the maximum radial amplitude of a corrugation is the straight-line distance, in the radial direction, between the point on the radially exterior surface SRE of the top of the corrugation and the point on the radially exterior surface SRE of the radially innermost bottom of one of the first and second bottoms of said corrugation.

In preferred embodiments, over at least 10%, preferably over at least 20% of the axial width of the corrugated crown layer separating each first and second bottom of the or each corrugation, the radial distance between the radially exterior surface SRE and the point on the radially exterior surface SRE of the radially innermost bottom of one of the first and second bottoms of the or each corrugation is greater than or equal to 1.0 mm, preferably greater than or equal to 1.5 mm. In other preferred embodiments, over at least 10%, preferably over at least 20% of the axial width of the corrugated crown layer separating each first and second bottom of the or each corrugation, the radial distance between the radially exterior surface SRE and the point on the radially exterior surface SRE of the radially innermost bottom of one of the first and second bottoms of the or each corrugation is less than or equal to 3.0 mm, preferably less than or equal to 2.5 mm.

In preferred embodiments, the corrugated crown layer is the radially outermost layer of the crown reinforcement. In certain embodiments of tyres for passenger vehicles, the radially outermost layer of the crown reinforcement is the hooping layer.

In advantageous embodiments, the or each corrugated crown layer comprises a plurality of corrugations.

Preferably, the or each corrugated crown layer extends axially from one side to the other of the median plane of the tyre.

In one optional embodiment, the tyre comprises two sidewall inserts arranged one on each side of the median plane of the tyre, each sidewall insert being arranged axially between the exterior surface of one of the sidewalls and the interior surface of said sidewall, each sidewall insert comprising at least one elastomeric composition referred to as rigid, the or each rigid elastomeric composition of each sidewall insert having a modulus at 10% extension greater than or equal to 4 MPa.

Thus, in a first variant, it is possible to have two sidewall inserts of sidewalls arranged in the two sidewalls of the tyre, these two sidewall inserts of sidewalls having the same rigid elastomeric composition(s).

In a second variant, it is possible to have two sidewall inserts arranged in the two sidewalls of the tyre, these two sidewall inserts comprising rigid elastomeric composition(s) having different moduli at 10% extension. In particular, in the case where the tyre has a mounting direction indicating an exterior side and an interior side of the tyre for mounting it on a vehicle, preference will be given to the case in which the sidewall insert of the sidewall intended to be on the exterior side has one or more rigid elastomeric composition(s) having a modulus at 10% extension that is less than the modulus at 10% extension of the rigid elastomeric composition(s) of the sidewall insert of the sidewall intended to be on the interior side, this interior side being intended to be more highly loaded in the event of running at zero pressure, taking into account the camber of the vehicle.

In an optional and advantageous embodiment, ENG≤15 mm. Thus, by further reducing the axial distance ENG, the compromise is further improved, increasing comfort and reducing the rolling resistance while maintaining the handling.

In an optional and advantageous embodiment, ENG≥5 mm, preferably ENG≥10 mm. If the axial distance ENG is reduced too much, the compromise is shifted in favour of increased comfort and reduced rolling resistance, but at the expense of handling.

In an optional embodiment, with the tread comprising at least one rib and first and second cuts adjacent to the rib, the top of said corrugation of said corrugated crown layer is arranged plumb with the rib and each first and second bottom of said corrugation of said corrugated crown layer is arranged plumb respectively with each first and second cut adjacent to the rib.

The portion of the corrugated crown layer arranged plumb with a rib or a cut is the axial portion of the corrugated crown layer delimited by axial ends defined by two circumferential planes perpendicular to the axis of rotation of the tyre and passing respectively through the axial ends of the rib or of the cut. Thus, a top of a corrugation of the corrugated crown layer is plumb with the rib if this top is included axially between the two circumferential planes passing through the axial ends of the rib and described above. Similarly, a bottom of a corrugation of the corrugated crown layer is plumb with a cut if this bottom is included axially between the two circumferential planes passing through the axial ends of the cut and described above.

The expression “cut adjacent to the rib” should be understood to mean that no other cut is arranged axially between the cut and the rib.

A cut denotes either a groove or a sipe, and forms a space opening onto the tread surface.

A sipe or a groove has, on the tread surface, two main characteristic dimensions: a width and a curvilinear length which are such that the curvilinear length is at least equal to two times the width. A sipe or a groove is therefore delimited by at least two main lateral faces determining its curvilinear length and connected by a bottom face, the two main lateral faces being separated from one another by a non-zero distance referred to as the width of the cut.

The width of a cut is, on a new tyre, the maximum distance between the two main lateral faces measured, when the cut is not chamfered, at a radial dimension coincident with the tread surface and, when the cut is chamfered, at the radially outermost radial dimension of the cut that is radially inside the chamfer. The width is measured substantially perpendicularly to the main lateral faces.

The axial width of a cut is, for its part, measured in the axial direction of the tyre, for example in a meridian section plane of the tyre.

A sipe is such that the distance between the main lateral faces is suitable for allowing the main lateral faces that delimit said sipe to come into at least partial contact in the contact patch, in particular when the tyre is new and under normal running conditions, in particular including the fact that the tyre is under nominal load and at nominal pressure.

A groove is such that the distance between the main lateral faces is such that these main lateral faces cannot come into contact with one another under normal running conditions, in particular including the fact that the tyre is under nominal load and at nominal pressure.

A cut may be transverse or circumferential.

A transverse cut is such that the cut extends in an overall direction forming an angle strictly greater than 30°, preferably greater than or equal to 45° with the circumferential direction of the tyre. The overall direction is the shortest curve joining the two ends of the cut and parallel to the tread surface. A transverse cut may be continuous, i.e., not interrupted by a tread block or another cut, such that the two main lateral faces determining its length are uninterrupted along the length of the transverse cut. A transverse cut may also be discontinuous, i.e., interrupted by one or more tread blocks and/or one or more cuts, such that the two main lateral faces determining its length are interrupted by one or more tread blocks and/or one or more cuts.

A circumferential cut is such that the cut extends in an overall direction forming an angle less than or equal to 30°, preferably less than or equal to 10° with the circumferential direction of the tyre. The overall direction is the shortest curve joining the two ends of the cut and parallel to the tread surface. In the case of a continuous circumferential cut, the two ends coincide with each other and are joined by a curve that makes a full circuit around the tyre. A circumferential cut may be continuous, i.e., not interrupted by a tread block or another cut, such that the two main lateral faces determining its length are uninterrupted over a full circuit around the tyre. A circumferential cut may also be discontinuous, i.e., interrupted by one or more tread blocks and/or one or more cuts, such that the two main lateral faces determining its length are interrupted by one or more tread blocks and/or one or more cuts over a full circuit around the tyre.

In the case of a circumferential cut situated outside the median plane of the tyre, the lateral faces are referred to as the axially interior face and axially exterior face, the axially interior face being arranged, at a given azimuth, axially to the inside of the axially exterior face in relation to the median plane.

Each circumferential cut comprises axially interior and exterior axial ends. Irrespective of whether or not a circumferential cut has a chamfer, each axially interior and exterior end is located respectively on each axially interior or exterior edge.

In the case of a transverse cut, the lateral faces are referred to as the leading face and trailing face, the leading face being the one of which the edge, for a given circumferential line, enters the contact patch before the edge of the trailing face.

In some embodiments, the or each circumferential cut is chamfered. A chamfer of a circumferential cut can be a straight chamfer or a rounded chamfer. A straight chamfer is formed by a planar face that is inclined with respect to the axially interior and exterior face that it extends as far as the axially interior or exterior edge axially delimiting the circumferential cut. A rounded chamfer is formed by a curved face that merges tangentially into the axially interior or exterior face that it extends. A chamfer of a circumferential cut is characterized by a height and a width that are respectively equal to the radial distance and to the axial distance between the common point shared by the axially interior or exterior face extended by the chamfer, and the axially interior or exterior edge axially delimiting the circumferential cut.

In some embodiments, the or each transverse cut is chamfered. In other words, each transverse cut is radially delimited by leading and trailing faces that circumferentially delimit said transverse cut and are connected to one another by a bottom face that radially inwardly delimits said transverse cut. A chamfer of a transverse cut may be a straight chamfer or a rounded chamfer. A straight chamfer is formed by a planar face that is inclined with respect to the leading or trailing face that it extends as far as the leading or trailing edge circumferentially delimiting the transverse cut. A rounded chamfer is formed by a curved face that merges tangentially into the leading or trailing face that it extends. A chamfer of a transverse cut is characterized by a height and a width that are respectively equal to the radial distance and to the distance in a direction perpendicular to the leading or trailing faces between the common point shared by the leading or trailing face extended by the chamfer, and the leading or trailing edge circumferentially delimiting the transverse cut.

On a new tyre, the depth of a cut is the maximum radial distance between the bottom of the cut and its projection onto the ground when the tyre is running. The maximum value for the depths of the cuts is referred to as the tread pattern height.

In embodiments in which each adjacent first and second circumferential cut is relatively wide, particularly in the case of passenger vehicle tyres, each adjacent first and second circumferential cut has an axial width greater than or equal to 1.0 mm, preferably greater than or equal to 4.0 mm and more preferably ranging from 4.0 mm to 20.0 mm.

In embodiments in which each adjacent first and second circumferential cut is relatively deep, in particular in the case of passenger vehicle tyres, each adjacent first and second circumferential cut has a depth greater than or equal to 50% of the tread pattern height Hs. Thus, preferably, each adjacent first and second circumferential cut has a depth ranging from 4.0 mm to the tread pattern height.

In highly advantageous embodiments, with the tread comprising a plurality of ribs and a plurality of cuts, each rib of the plurality of ribs having adjacent first and second cuts of the plurality of cuts, the corrugated crown layer comprises, in the central part of the crown reinforcement, a plurality of corrugations, the top of each corrugation of said corrugated crown layer is arranged plumb with one of the ribs and each first and second bottom of each corrugation of said corrugated crown layer is arranged plumb respectively with each first and second cut adjacent to said rib.

In one advantageous embodiment, each first and second cut adjacent to the or each rib is a circumferential cut.

In advantageous variants in which the corrugated crown layer is the radially outermost crown reinforcement layer, the difference between:
the minimum radial distance between the or each top of the or each corrugation of the radially outermost crown reinforcement layer and the tread surface,
the depth of the or each circumferential cut plumb with which each first and second bottom of said or each corrugation is arranged is less than or equal to 2 mm.

The minimum radial distance between the top of the or each corrugation and the tread surface is measured here between the radially exterior surface SRE of said corrugated crown layer and the tread surface.

In advantageous embodiments, the modulus at 10% extension of the or each rigid elastomeric composition is greater than or equal to 5 MPa, preferably greater than or equal to 6 MPa.

In advantageous embodiments, the modulus at 10% extension of the or each rigid elastomeric composition is less than or equal to 20 MPa, preferably less than or equal to 15 MPa and more preferably less than or equal to 13 MPa. Although it improves the handling of the tyre and its ability to run flat, too high a stiffness can nevertheless reduce the comfort of the vehicle. Thus, it is preferable not to use a sidewall insert that is too rigid.

In other advantageous embodiments, the radially interior end of the sidewall insert is arranged radially to the inside of the equator of the tyre.

Preferably, the radially interior end of the sidewall insert is arranged radially and axially to the inside of a straight line normal to the interior surface and passing through the radially exterior end of the exterior surface of the bead of the tyre.

In some embodiments, the radially interior end is the radially interior end of the rigid elastomeric composition or the radially innermost end of the radially interior ends of the rigid elastomeric compositions of the assembly. In other embodiments, the radially interior end is the innermost end of the radially interior ends of the rigid or flexible elastomeric compositions of the insert.

Optionally, but advantageously, the or each sidewall insert has a cross section in the general shape of a crescent. Thus, the width of the cross section of the sidewall insert is minimal at its radially interior and exterior ends and is maximal between these ends.

In embodiments that provide relatively high run-flat capability, the thickness EP at the equator of the rigid elastomeric composition or of the assembly of the rigid elastomeric compositions satisfies the following relationships:
EP≥(LI−85.3)/2.2 for LI ranging from 86 to 101,
EP≥(LI−96)/0.7 for LI ranging from 102 to 116,
   LI being the load index of the tyre.

Indeed, the inventors have discovered that, for a run-flat capability to be achieved, the higher the load index of the tyre, the higher the thickness EP at the equator. What is meant by the run-flat capability to be achieved is the distance that the tyre is able to cover at a speed equal to 80 km/h under 80% of the nominal load of the tyre as indicated in the European Tyre and Rim Technical Organisation (ETRTO) Standards Manual, 2021.

Optionally, if further improved run-flat capability is desired, the thickness EP at the equator of the rigid elastomeric composition or of the assembly of the rigid elastomeric compositions satisfies the following relationships:
EP≥(LI−78.8)/2.8 for LI ranging from 86 to 101,
EP≥(LI−92.8)/0.9 for LI ranging from 102 to 116,
   LI being the load index of the tyre.

In embodiments that provide an improved compromise between run-flat capability, rolling resistance and tyre mass, the thickness EP at the equator of the rigid elastomeric composition or of the assembly of the rigid elastomeric compositions satisfies the following relationships:
EP≤(LI−68.5)/3.1 for LI ranging from 86 to 101,
EP≤(LI−81.1)/1.4 for LI ranging from 102 to 116,
   LI being the load index of the tyre.

Optionally, if a further improved compromise between run-flat capability, rolling resistance and tyre mass is desired, the thickness EP at the equator of the rigid elastomeric composition or of the assembly of the rigid elastomeric compositions satisfies the following relationships:
EP≤(LI−71.8)/3.1 for LI ranging from 86 to 101,
EP≤(LI−84.1)/1.4 for LI ranging from 102 to 116,
   LI being the load index of the tyre.

In other embodiments in which it is desired to give preference to the rolling resistance and the mass of the tyre over the run-flat capability, for example by reducing the distance the tyre can cover at 80 km/h, the thickness EP at the equator can be further reduced.

The thickness EP at the equator of the rigid elastomeric composition or of the assembly of rigid elastomeric compositions is defined, in a meridian section plane, as the thickness of the rigid elastomeric composition or of the assembly of the rigid elastomeric compositions in the axial direction passing through the equator of the tyre.

The load index is as indicated in the manual of the European Tyre and Rim Technical Organisation or “ETRTO” standard, 2021, and is indicated on the tyre in the form of a marking. In fact, a tyre generally has, on at least one of the sidewalls, a marking conforming to the marking in the ETRTO Standards Manual, 2021 indicating the size of the tyre in the form X/Y a V LI B where X denotes the nominal section width, Y denotes the nominal aspect ratio, a denotes the structure and may be R or ZR, V denotes the nominal rim diameter, LI denotes the load index and β denotes the speed symbol.

In the preferred embodiment in which the or each sidewall insert comprises a rigid elastomeric composition, or even consists of a rigid elastomeric composition, the thickness EP at the equator is the thickness of the rigid elastomeric composition.

In the other embodiments in which the or each sidewall insert comprises several rigid elastomeric compositions, the thickness at the equator is the thickness of the assembly of the rigid elastomeric compositions, i.e. the value of the sum of the thicknesses at the equator of each rigid elastomeric composition. In variants in which the sidewall insert comprises, in addition to the rigid elastomeric compositions, one or more elastomeric compositions, referred to as flexible, of which the modulus at 10% extension is strictly less than 4 MPa, the thickness EP at the equator does not take into account the thickness of the or each flexible elastomeric composition, the thickness EP at the equator being defined as the thickness of the assembly of the rigid elastomeric compositions.

In the variants in which there are two sidewall inserts arranged in the two sidewalls of the tyre, these two sidewall inserts may have, in addition to optionally comprising rigid elastomeric composition(s) having different moduli at 10% extension, different thicknesses EP at the equator. In particular, in the case where the tyre has a mounting direction indicating an exterior side and an interior side of the tyre for mounting it on a vehicle, preference will be given to the scenario in which the sidewall insert of the sidewall intended to be on the exterior side has a thickness at the equator EPe that is less than the thickness at the equator EPi of the sidewall insert of the sidewall intended to be on the interior side.

Optionally, the tyre comprises:
a carcass reinforcement comprising at least one carcass layer anchored in the or each bead and extending radially in the or each sidewall and axially in the crown block radially to the inside of the crown reinforcement, and
an inner-liner layer bearing the interior surface of the tyre, the sidewall insert is arranged axially between the inner-liner layer and the axially innermost carcass layer.

Optionally, the or each carcass layer is delimited axially by two axial ends and comprises carcass reinforcing elements extending axially from one axial end to the other of said carcass layer in a main direction that optionally and preferably forms, with the circumferential direction of the tyre, an angle, expressed as an absolute value, greater than or equal to 60°, preferably ranging from 80° to 90°.

In other embodiments, it may be envisaged that the sidewall insert is arranged axially between the axially outermost carcass layer and the exterior surface of the tyre.

In advantageous embodiments, the crown reinforcement comprises a working reinforcement comprising at least one working layer and a hoop reinforcement comprising at least one hooping layer, the hoop reinforcement being arranged radially to the outside of the working reinforcement, and the crown block is preferably not provided with an annular reinforcing structure.

In certain variants, the carcass reinforcement comprises a single carcass layer anchored in the or each bead and extending radially in the or each sidewall and axially in the crown block radially to the inside of the crown reinforcement. The term “single carcass layer anchored in the or each bead” means that the carcass reinforcement is, with the exception of the carcass layer, devoid of any layer reinforced by reinforcing elements and anchored in the or each bead. The reinforcing elements of such reinforced layers excluded from the carcass reinforcement of the tyre comprise metal reinforcing elements and textile reinforcing elements. Highly preferably, the carcass reinforcement is made up of the single carcass layer.

In other variants, the carcass reinforcement comprises first and second carcass layers anchored in the or each bead and extending radially in the or each sidewall and axially in the crown block radially to the inside of the crown reinforcement, the sidewall insert is arranged axially to the inside of the first carcass layer.

In advantageous embodiments, the crown reinforcement comprises a working reinforcement comprising at least one working layer and a hoop reinforcement comprising at least one hooping layer, the hoop reinforcement being arranged radially to the outside of the working reinforcement, the or each hooping layer comprising, in the central part of the crown reinforcement, at least one corrugation.

Optionally, the or each hooping layer is delimited axially by two axial ends. The or each hooping layer comprises one or more hoop reinforcing elements wound circumferentially in a helical manner in such a way as to extend axially in a main direction from one axial end to the other of the hooping layer. Optionally and preferably, the main direction forms, with the circumferential direction of the tyre, an angle with an absolute value less than or equal to 10°, preferably less than or equal to 7° and more preferably less than or equal to 5°.

Optionally, the or each working layer is delimited axially by two axial ends. The or each working layer comprises working reinforcing elements that extend axially from one axial end to the other, substantially parallel to each other in a main direction which optionally and preferably forms, with the circumferential direction of the tyre, an angle with an absolute value that is strictly greater than 10°, preferably between 15° and 50° and more preferably between 25° and 45°.

In even more advantageous embodiments, the or each working layer comprises at least one corrugation.

Preferably, the or each hoop and working reinforcing element is a filamentary reinforcing element.

Preferably, when the tyre is inflated to its nominal pressure, the interior surface does not have a point of inflection arranged in line with the crown reinforcement. The part of the interior surface arranged in line with the crown reinforcement is the part of the interior surface arranged axially between the axial limits of the axially widest crown layer projected radially onto the interior surface.

Preferably, in each meridian plane, the or each central rib has a substantially flat tread surface that is intended to come into contact with the ground. The expression “substantially flat” should be understood to mean that the radial distance between the radially outermost point(s) of the tread surface of said central rib and the radially innermost point(s) of the tread surface is strictly less than 0.2 mm, preferably less than or equal to 0.1 mm, and preferably substantially zero. A central rib is a rib arranged axially between two adjacent circumferential cuts.

The invention will be better understood from reading the following description, given solely by way of non-limiting example and with reference to the drawings in which:

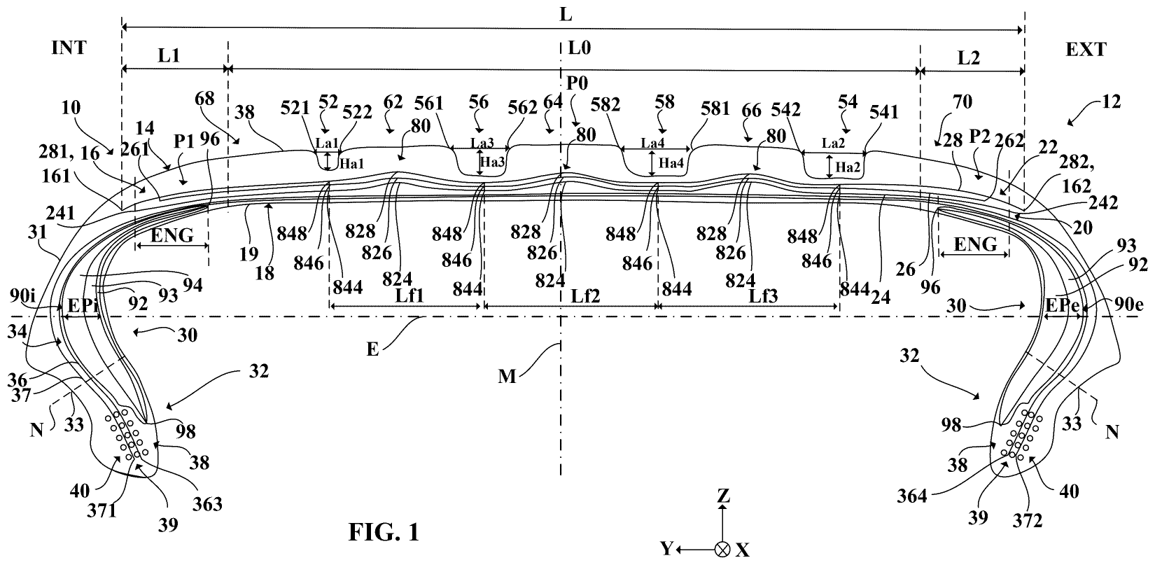

FIG. 1 is a view, in a meridian section plane parallel to the axis of rotation of the tyre, of a tyre according to a first embodiment of the invention,

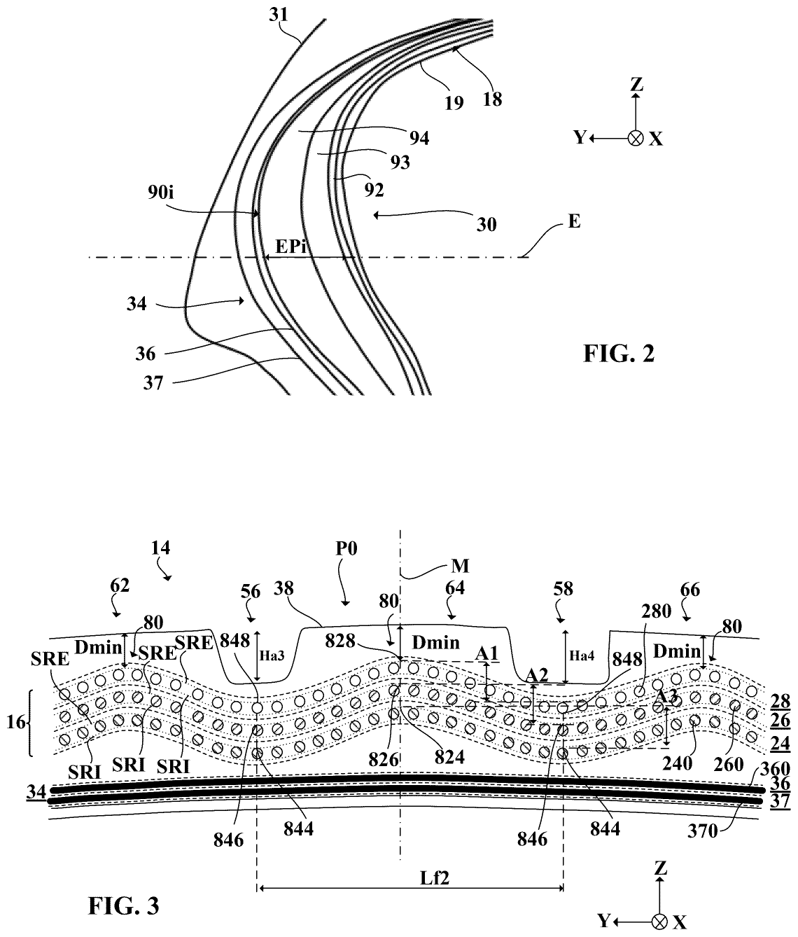

FIG. 2 is a detailed view of one of the sidewalls of the tyre of FIG. 1,

FIG. 3 is a detailed view of the crown block of the tyre of FIG. 1,

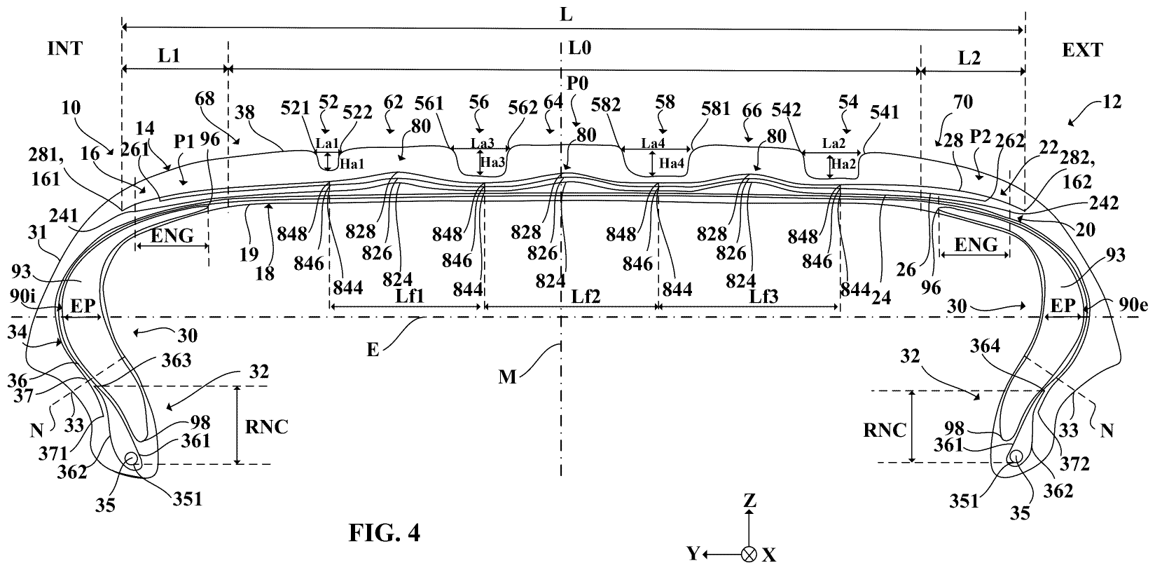

FIGS. 4, 5 and 6 are views similar to that of FIG. 1 of tyres according to second, third and fourth embodiments of the invention.

A frame of reference X, Y, Z corresponding respectively to the usual axial (Y), radial (Z) and circumferential (X) directions of a tyre is shown in the figures relating to the tyre.

FIG. 1 shows a tyre according to the invention, denoted by the general reference 10. The tyre 10 has a substantially toroidal shape about an axis of revolution substantially parallel to the axial direction Y. The tyre 10 is intended for a passenger vehicle and has the dimensions 345/25 ZR21 104 Y. In the various figures, the tyre 10 is shown as new, i.e., when it has not yet been run.

The tyre 10 comprises a crown block 12 comprising a tread 14 intended to come into contact with a ground during running and a crown reinforcement 16 extending in the crown block 12 in the circumferential direction X. The tyre 10 also comprises an inner-liner layer 18 which is impervious to an inflation gas and is intended to delimit, with a support on which the tyre 10 is mounted, an interior cavity once the tyre 10 has been mounted on the mounting support, for example a rim, this cavity being intended to be pressurized by the inflation gas. The inner-liner layer 18 carries an interior surface 19 of the tyre 10. The tyre 10 also has an exterior surface 31.

The crown reinforcement 16 comprises a working reinforcement 20 and a hoop reinforcement 22, each of these reinforcements 20, 22 comprising at least one crown layer. The working reinforcement 16 comprises at least one working layer and here comprises two working layers comprising a radially interior working layer 24 arranged radially inside a radially exterior working layer 26. The radially innermost crown layer of the crown reinforcement 16 is here the radially interior working layer 24.

The hoop reinforcement 22 comprises at least one hooping layer and in this instance comprises one hooping layer 28.

The crown reinforcement 16 is arranged radially to the inside of the tread 14. In this instance, the hoop reinforcement 22, in this case the hooping layer 28, is arranged radially to the outside of the working reinforcement 20 and is therefore interposed radially between the working reinforcement 20 and the tread 14.

The tyre 10 comprises two sidewalls 30 extending the crown block 12 radially towards the inside. The tyre 10 further comprises two beads 32 radially to the inside of the sidewalls 30. Each sidewall 30 connects each bead 32 to the crown block 12. The tyre 10 has a mounting direction indicating an exterior side EXT and an interior side INT of the tyre for mounting it on a vehicle.

The tyre 10 comprises a carcass reinforcement 34. The crown reinforcement 16 is arranged radially between the tread 14 and the carcass reinforcement 34. The carcass reinforcement 34 comprises first and second carcass layers 36, 37 anchored in each bead 32 and extending radially in each sidewall 30 and axially in the crown block 12 radially to the inside of the crown reinforcement 16. The second carcass layer 37 is arranged axially and radially to the outside of the first carcass layer 36.

For the purpose of anchoring the first and second carcass layers 36, 37, the tyre 10 comprises a plurality of circumferential reinforcing elements 38, 39, 40. At least one portion of each first and second carcass layer 36, 37 is arranged axially between at least two circumferential reinforcing elements 38, 39, 40. Here, each reinforcing element 38, 39, 40 comprises a continuous filamentary reinforcing element wound over several circumferential turns, for example as described in WO 2021/123522.

The crown reinforcement 16 comprises two axial ends 161, 162 coinciding here with the ends of the axially widest layer of the crown reinforcement 16, in this instance the axial ends 281, 282 of the hooping layer 28. The crown reinforcement 16 comprises a central part P0 of axial width L0 equal to 80% of the axial width L of the crown reinforcement 16, here of the axial width of the hooping layer 28, and axially centred on the median plane M. The crown reinforcement 16 also comprises lateral parts P1, P2 arranged axially one on each side of the central part P0 and each having an axial width L1=L2 equal to 10% of the axial width L of the crown reinforcement 16.

When the tyre is inflated to its nominal pressure, the interior surface 19 does not have a point of inflection arranged in line with the crown reinforcement 16, that is to say that the interior surface 19 does not have a point of inflection between the axial ends 161, 162.

Each working layer 24, 26, hooping layer 28 and carcass layer 36 comprises a polymeric matrix, in this case elastomeric, in which one or more reinforcing elements of the corresponding layer are embedded, in this case filamentary reinforcing elements which will be described in particular with reference to FIGS. 1 and 3.

The hoop reinforcement 22, here the hooping layer 28, is delimited axially by two axial ends 161, 162. The hoop reinforcement 22 comprises one or more filamentary hooping reinforcing elements 280 wound circumferentially and helically so as to extend axially from one axial end of the hooping layer 28 to the other in a main direction DO. The main direction DO forms, with the circumferential direction X of the tyre 10, an angle AF which, as an absolute value, is less than or equal to 10°, preferably less than or equal to 7°, and more preferably less than or equal to 5°. In this case, AF=−5°.

The radially interior working layer 24 is delimited axially by two axial ends 241, 242. The radially interior working layer 24 comprises filamentary working reinforcing elements 240 extending axially from one axial end to the other substantially parallel to each other in a main direction D1. Similarly, the radially exterior working layer 26 is delimited axially by two axial ends 261, 262. The radially exterior working layer 26 comprises filamentary working reinforcing elements 260 extending axially from the axial end to the other substantially parallel to each other in a main direction D2. Each main direction D1, D2 forms, with the circumferential direction X of the tyre 10, respective angles AT1 and AT2 of opposite orientations. Each main direction D1, D2 respectively forms, with the circumferential direction X of the tyre 10, an angle AT1, AT2 which, in terms of absolute value, is strictly greater than 10°, preferably ranging from 15° to 50° and more preferentially ranging from 25° to 45°. In this case, AT1=−33° and AT2=+33°.

Each first and second carcass layer 36, 37 is delimited axially respectively by two axial ends 363, 364 and 371, 372. Each first and second carcass layer 36, 37 respectively comprises filamentary carcass reinforcing elements 360, 370 extending axially from one axial end of the carcass layer 36, 37 to the other along a main direction D3 forming, with the circumferential direction X of the tyre 10, an angle AC, which, in terms of absolute value, is greater than or equal to 60°, preferably ranging from 80° to 90° and in this case AC=+90°.

Each filamentary hoop reinforcing element 280, working reinforcing element 240, 260 and carcass reinforcing element 360, 370 is, for example, identical to those described in application WO 2021/123522. Other variants can be used, in particular as regards the filamentary carcass reinforcing elements 360, 370 which may comprise rayon, aramid, polyester elements or else combinations of these elements.

With reference to FIGS. 1 and 3, the tread 14 comprises a tread surface 38 via which the tread 14 comes into contact with the ground.

The tread 14 comprises several circumferential cuts, here several circumferential grooves, comprising first, second, third and fourth circumferential cuts respectively designated by the references 52, 54, 56, 58. Each circumferential cut 52 to 58 is axially delimited by an axially exterior end respectively designated by the reference 521, 541, 561, 581 and by an axially interior end respectively designated by the reference 522, 542, 562, 582. Each circumferential cut 52 to 58 has a depth respectively designated by the reference Ha1, Ha2, Ha3, Ha4, and ranging from 4.0 mm to the tread pattern height Hs. Each depth Ha1, Ha, Ha3, Ha4 is greater than or equal to 50% of the tread pattern height Hs. Here, Hs=Ha3=Ha4=7.0 mm and Ha1=Ha2=6.5 mm. Each circumferential cut 52 to 58 has an axial width respectively designated by the reference La1, La2, La3, La4 and greater than or equal to 1.0 mm, preferably greater than or equal to 4.0 mm and more preferably ranging from 4.0 mm to 20.0 mm. In this case, La1=4.0 mm, La2=15.0 mm, La3=10.0 mm and La4=17.5 mm.

The tread 14 also comprises several central ribs and here first, second and third central ribs respectively designated by the references 62, 64, 66. Each central rib 62, 64, 66 is arranged axially between two of the adjacent circumferential cuts 52 to 58 and is delimited axially by two adjacent circumferential cuts 52 to 58. Each central rib 62, 64, 66 is axially delimited by an axially interior end and by an axially exterior end, each axially interior and exterior end being an axially interior or exterior end of the circumferential cuts 52 to 58. The axially interior and exterior ends of each central rib 62, 64, 66 are adjacent to each other. In this particular case, the central rib 62 is axially delimited by the axially interior end 522 of the circumferential cut 52 and by the axially exterior end 561 of the circumferential cut 56. The central rib 64 is axially delimited by the axially interior end 562 of the circumferential cut 56 and by the axially interior end 582 of the circumferential cut 58. The central rib 66 is axially delimited by the axially exterior end 581 of the circumferential cut 58 and by the axially interior end 542 of the circumferential cut 54. Thus, the circumferential cuts 52, 56 are adjacent to the ribs 62, the circumferential cuts 56, 58 are adjacent to the rib 64, and the circumferential cuts 58, 54 are adjacent to the rib 66. Each central rib 62, 64, 66 has a substantially flat tread surface intended to come into contact with the ground.

The tread 14 also comprises first and second lateral ribs 68, 70.

Even though this is not visible in FIGS. 1 and 3, each central rib 62, 64, 66 and each lateral rib 68, 70 comprises transverse cuts made in each central rib 62, 64, 66 and each lateral rib 68, 70.

FIG. 3 depicts:
in dotted line, the radially exterior surfaces SRE passing through the radially outermost points of the radially outermost reinforcing elements 240, 260 and 280 of each crown layer 24, 26, 28,
in dotted line, the radially interior surfaces SRI passing through the radially innermost points of the radially innermost reinforcing elements 240, 260 and 280 of each crown layer 24, 26, 28,
in dashed line, the interfaces of the polymeric matrices in which the reinforcing elements of each crown layer 24, 26, 28 are embedded.

With reference to FIGS. 1 and 3, each crown layer, here each working layer 24, 26 and the hooping layer 28, comprises, in the central part P0 of the crown reinforcement 16, a plurality of corrugations 80 and is therefore referred to as corrugated. Each corrugation 80 of each crown layer 24, 26, 28 comprises a top 824, 826, 828 respectively of each corrugated crown layer 24, 26, 28, first bottoms 844, 846, 848 respectively of each corrugated crown layer 24, 26, 28 and second bottoms 844, 846, 848 respectively of each corrugated crown layer 24, 26, 28. The tops and bottoms are arranged in such a way that each top 824, 826, 828 is arranged axially between the first and second bottoms 844, the first and second bottoms 846 and the first and second bottoms 848, respectively. The tops and the bottoms are arranged in such a way that each top 824, 826, 828 is arranged radially to the outside of the first and second bottoms 844, of the first and second bottoms 846, and of the first and second bottoms 848, respectively. In FIG. 3, in the scenario in which radial distance measurements are to be made, the tops 824, 826, 828 and the bottoms 844, 846, 848 are considered on the radially exterior surface SRE of each layer concerned.

Each top 824, 826, 828 of each corrugation 80 of each corrugated crown layer 24, 26, 28 is arranged plumb with one of the central ribs 62, 64, 66. Each first and second bottom 844, 846, 848 of each corrugation 80 of each corrugated crown layer 24, 26, 28 is arranged plumb with each first and second cut 52 and 56, 56 and 58, 58 and 54, adjacent to each rib 62, 64, 66.

Each maximum radial amplitude A1, A2, A3 of each corrugation 80 of each corrugated crown layer 24, 26, 28 is greater than or equal to 1.0 mm, preferably greater than or equal to 1.5 mm and less than or equal to 3.0 mm, preferably less than or equal to 2.5 mm. In this instance, each maximum radial amplitude A1, A2, A3 is substantially equal to 2.0 mm.

Over at least 10%, preferably over at least 20% of the axial width Lf1, Lf2, Lf3 of each corrugated crown layer 24, 26, 28 separating each first and second bottom 844, 846, 848 of each corrugation 80, the radial distance between the radially exterior surface SRE and the radially innermost point on the radially exterior surface SRE of the bottom 844, 846, 848 of one of the first and second bottoms 844, 846, 848 of each corrugation 80 is greater than or equal to 1.0 mm, preferably greater than or equal to 1.5 mm and less than or equal to 3.0 mm, preferably less than or equal to 2.5 mm. In this instance, the radial distance is greater than or equal to 1.5 mm and less than or equal to 2.5 mm over approximately 30% of each axial width Lf1, Lf2, Lf3.

In addition, the difference between the minimum radial distance Dmin between, on the one hand, each top 828 of each corrugation 80 of the hooping layer 28 and the tread surface 38, and, on the other hand, the depth Ha2, Ha3, Ha4 of each circumferential cut 54, 56, 58 plumb with which each first and second bottom 848 of each corrugation 80 of the hooping layer 28 is arranged is less than or equal to 2 mm.

The tyre comprises two sidewall inserts 90i, 90e arranged respectively on the interior side INT and on the exterior side EXT of the tyre 10. The sidewall inserts 90i, 90e are arranged one on each side of the median plane of the tyre 10. Each sidewall insert 90i, 90e is arranged axially respectively between the exterior surface 31 of said sidewall 30 and the interior surface 19 of said sidewall 30. More specifically, each sidewall insert 90i, 90e is arranged axially between the inner-liner layer 18 and the axially innermost carcass layer, here the first carcass layer 36. Each sidewall insert 90i, 90e has a cross section in the general shape of a crescent.

The tyre 10 is suitable for running flat. Specifically, each sidewall insert 90i, 90e comprises at least one elastomeric composition referred to as rigid. The sidewall insert 90i comprises three elastomeric compositions 92, 93, 94 and the sidewall insert 90e comprises two elastomeric compositions 92, 93. The elastomeric composition 92 is a flexible elastomeric composition having a modulus MA10 at 10% extension that is strictly less than 4 MPa, in this case less than 3 MPa. Each elastomeric composition 93, 94 is a rigid elastomeric composition having a modulus MA10 at 10% extension that is greater than or equal to 4 MPa, preferably greater than or equal to 5 MPa, more preferably greater than or equal to 6 MPa and less than or equal to 20 MPa, preferably less than or equal to 15 MPa and more preferably less than or equal to 13 MPa. Here, the modulus MA10 at 10% extension of each rigid elastomeric composition 93, 94 is equal to 6 MPa and 9 MPa respectively. In order to formulate the various rigid elastomeric compositions, it is possible, for example, to use the teaching of WO2014184158, or WO2018111773.

Each sidewall insert 90 comprises a radially exterior end 96 and a radially interior end 98. Each radially exterior end 96 is arranged radially to the outside of the equator E and axially to the inside respectively of the axial end of the radially innermost crown layer of the crown reinforcement, here axially to the inside respectively of each axial end 241, 242 of the radially interior working layer 24. The axial distance ENG between each radially exterior end 96 and each axial end 241, 242 is such that ENG≤20 mm, preferably ENG≤15 mm and such that ENG≥5 mm, preferably ENG≥10 mm and here ENG=13 mm.

Each radially interior end 98 is arranged radially inside the equator E and radially and axially inside a straight line N normal to the interior surface 19 and passing through the radially exterior end 33 of the exterior surface 31 of each bead 32.

With reference to FIG. 2, each thickness of each elastomeric composition 92, 93, 94, 95, 96 at the equator is equal to 4.0 mm, 3.6 mm, 10.4 mm, 6.6 mm and 3.4 mm respectively. The thickness EPi at the equator of the assembly of rigid elastomeric compositions 93, 94 of the sidewall insert 90i satisfies the relationship EPi≥(LI−96)/0.7, preferably EPi≥ (LI−92.8)/0.9, LI being the load index of the tyre. In addition, the thickness EPi satisfies the relationship EPi≤(LI−81.1)/1.4, preferably EPi≤(LI−84.1)/1.4. In this case, LI=104 and EPi=14.0 mm.

Tyres according to second, third and fourth embodiments of the invention will now be described with reference to FIGS. 4, 5 and 6 respectively, in which elements analogous to those shown in the preceding figures are designated by identical references.

Unlike the tyre according to the first embodiment, the tyre 10 according to the second embodiment of FIG. 4 comprises a circumferential reinforcing element, in this case a bead wire 35 around which the first carcass layer 36 is wound so as to form an axially interior portion 361 and an axially exterior portion 362 arranged axially to the outside of the axially interior portion 361 and so that each axial end 363, 364 is arranged radially to the outside of each circumferential reinforcing element 35. Each axial end 363, 364 of the first carcass layer 36 anchored in each bead 32 is arranged radially to the inside of the equator E of the tyre. More precisely, each axial end 363, 364 of the carcass layer 36 is arranged at a radial distance RNC less than or equal to 30 mm from a radially interior end 351 of each circumferential reinforcing element 35 of each bead 32. In this case, RNC=23 mm.

Each axial end 371, 372 of the second carcass layer 37 is arranged radially to the inside of each axial end of the first layer 363, 364 and is arranged axially to the outside of the axially exterior portion 362 of the first carcass layer 36.

Also unlike the first embodiment, the tyre 10 according to the second embodiment comprises sidewall inserts 90 comprising the rigid elastomeric composition 93 and in this case constituted by the rigid elastomeric composition 93 having a modulus MA10 at 10% of extension that is equal to 6 MPa. In addition, the thickness at the equator of each sidewall insert 90, here the thickness EP at the equator of each rigid elastomeric composition 92, is substantially identical for the two sidewall inserts 90 and for example equal to 13 mm. In a variant (not shown) of this second embodiment, each axial end 371, 372 of the second carcass layer 37 is arranged axially between the axially interior and exterior portions 361 and 362 of the first carcass layer 36.

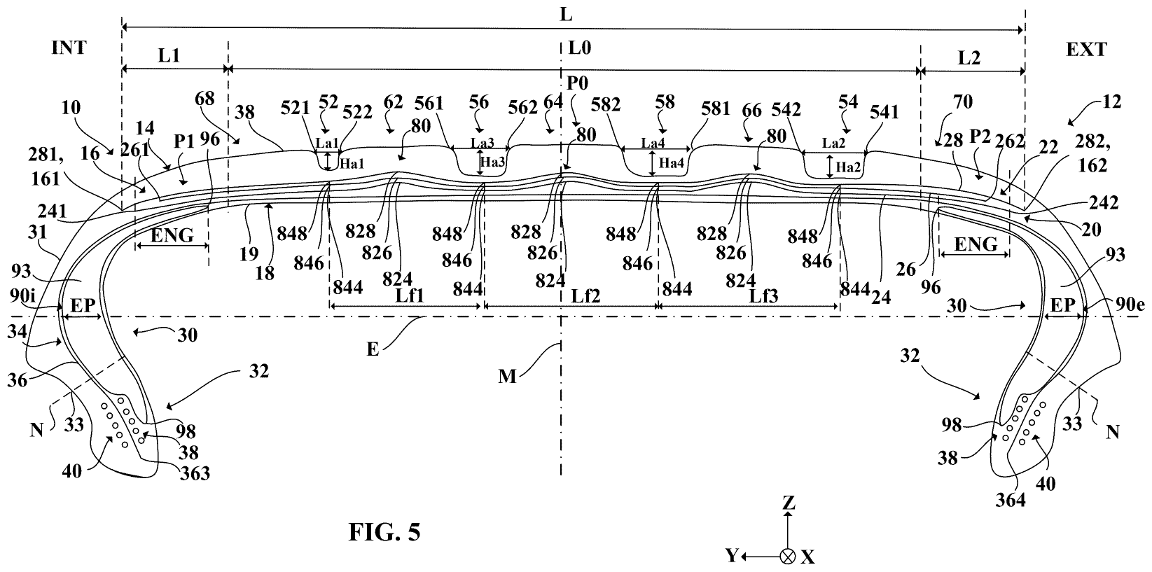

Unlike the tyre according to the second embodiment, the tyre 10 according to the third embodiment of FIG. 5 comprises a single carcass layer 36 anchored in each bead 32. The carcass layer 36 extends radially in each sidewall 30 and axially in the crown block 12, radially to the inside of the crown reinforcement 16. For the purpose of anchoring the carcass layer 36, the tyre 10 comprises an axially interior circumferential reinforcing element 38 arranged axially to the inside of the carcass layer 36 and an axially exterior circumferential reinforcing element 40 arranged axially to the outside of the carcass layer 36. These circumferential reinforcing elements 38, 40 are identical to those described with reference to the first embodiment.

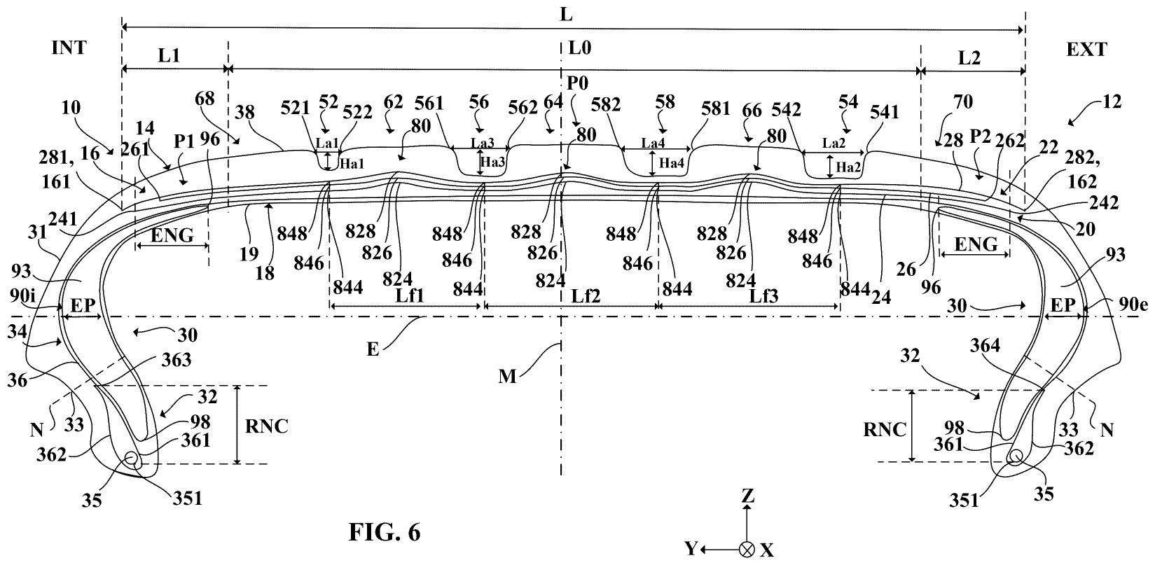

Unlike the tyre according to the third embodiment, the tyre 10 according to the fourth embodiment of FIG. 6 is such that, for the purpose of anchoring the single carcass layer 36, the tyre 10 comprises a circumferential reinforcing element, in this case a bead wire 35 around which the carcass layer 36 is wound so as to form an axially interior portion 361 and an axially exterior portion 362 arranged axially to the outside of the axially interior portion 361 and so that each axial end 363, 364 is arranged radially to the outside of each circumferential reinforcing element 35. Each axial end 363, 364 of the carcass layer 36 anchored in each bead 32 is arranged radially to the inside of the equator E of the tyre. More precisely, each axial end 363, 364 of the carcass layer 36 is arranged at a radial distance RNC less than or equal to 30 mm from a radially interior end 351 of each circumferential reinforcing element 35 of each bead 32. In this case, RNC=23 mm as in the second embodiment.

In a variant (not shown) of this fourth embodiment, it is possible to envisage for each axial end 363, 364 of the carcass layer 36 anchored in each bead 32 and wrapped around to be arranged radially to the outside of the equator E and even more preferably arranged axially to the inside of one of the axial ends of one of the crown layers of the crown reinforcement 16.

### Comparative Tests

The tyre 10 according to the first embodiment and in accordance with the invention, a reference tyre R not in accordance with the invention and a control tyre T also not in accordance with the invention were compared.

The reference tyre R is identical to the tyre 10 except that it does not have a corrugated crown layer and that the axial distance ENG is approximately 25 mm.

The control tyre T is identical to the tyre 10 except that it does not have a corrugated crown layer.

The tyres 10, R and T were tested in order to evaluate rolling resistance, mass, comfort and handling in a subjective test. The subjective tests were carried out on a track by fitting a Corvette Z06 vehicle with these different tyres.

The results of these tests are given in Table 1 below in which the caption “Ref.” indicates a reference value for the corresponding performance.

TABLE 1

| | R | T | 10 |
|---|---|---|---|
| Rolling resistance | Ref. | + | + |
| Comfort | Ref. | + | + |
| Mass | Ref. | + | + |
| Handling | Ref. | − | ++ |

In Table 1, “+” or “++” indicates that the performance aspect concerned has improved. Conversely, “−” indicates that the performance aspect concerned has worsened.

Table 1 shows that it is indeed the combination of a corrugated crown layer and a relatively small axial distance ENG that enables the desired compromise to be improved. In fact, while the reduction in the axial distance ENG in the control tyre T makes it possible to reduce the rolling resistance with respect to the reference tyre R, this reduction leads to a worsening of the handling of the control tyre T in relation to the reference tyre R. Combining the reduction in the axial distance ENG with the use of a corrugated crown layer avoids worsening the handling of the tyre and, surprisingly, this is even significantly improved whereas the expectation was that it would be, if not worse, at best maintained at the level of handling of the reference tyre R.

The invention is not limited to the embodiments described above.

1.-15. (canceled)

16. A tire comprising a crown block, two beads, and two sidewalls connecting each bead to the crown block,
the crown block comprising a tread and a crown reinforcement arranged radially to an inside of the tread,
the tire further comprising a sidewall insert arranged axially between an exterior surface of one of the sidewalls and an interior surface of the sidewall,
the sidewall insert comprising at least one rigid elastomeric composition, the at least one rigid elastomeric composition of the sidewall insert having a modulus at 10% extension greater than or equal to 4 MPa,
wherein the crown reinforcement comprises a central part of axial width equal to 80% of an axial width of the crown reinforcement and axially centered on a median plane of the tire,
wherein the crown reinforcement comprises at least one corrugated crown layer comprising reinforcing elements embedded in a polymeric matrix, the at least one corrugated crown layer comprising, in the central part of the crown reinforcement, at least one corrugation, the or each corrugation of the at least one corrugated crown layer comprising a top of the at least one corrugated crown layer and first and second bottoms of the at least one corrugated crown layer which are adjacent to the top and arranged so that:
the top is arranged axially between the first and second bottoms, and
the top is arranged radially to an outside of each first and second bottom, and
wherein a radially exterior end of the sidewall insert is arranged:
radially to an outside of an equator of the tire, and
axially to an inside of an axial end of a radially innermost crown layer of the crown reinforcement and at an axial distance ENG≤20 mm from the axial end.

17. The tire according to claim 16, wherein ENG≤15 mm.

18. The tire according to claim 16, wherein ENG≥5 mm.

19. The tire according to claim 16, wherein the tread comprises at least one rib and first and second cuts adjacent to the at least one rib,
the top of the corrugation of the at least one corrugated crown layer is arranged plumb with the at least one rib, and
each first and second bottom of the corrugation of the at least one corrugated crown layer is arranged plumb respectively with each first and second cut adjacent to the at least one rib.

20. The tire according to claim 16, wherein the tread comprises a plurality of ribs and a plurality of cuts, each rib of the plurality of ribs having first and second cuts adjacent to the plurality of ribs,
the at least one corrugated crown layer comprises, in the central part of the crown reinforcement, a plurality of corrugations,
the top of each corrugation of the at least one corrugated crown layer is arranged plumb with one of the ribs, and
each first and second bottom of each corrugation of the at least one corrugated crown layer is arranged plumb respectively with each first and second cut adjacent to the rib.

21. The tire according to claim 16, wherein the modulus at 10% extension of the at least one rigid elastomeric composition is greater than or equal to 5 MPa.

22. The tire according to claim 16, wherein the modulus at 10% extension of the at least one rigid elastomeric composition is less than or equal to 20 MPa.

23. The tire according to claim 16, wherein a radially interior end of the sidewall insert is arranged radially to the inside of the equator (E) of the tire.

24. The tire according to claim 16, wherein a thickness EP at an equator of the at least one rigid elastomeric composition satisfies the following relationships:
EP≥(LI−85.3)/2.2 for LI ranging from 86 to 101, and
EP≥(LI−96)/0.7 for LI ranging from 102 to 116,
LI being a load index of the tire.

25. The tire according to claim 16, wherein a thickness EP at an equator of the at least one rigid elastomeric composition satisfies the following relationships:
EP≤(LI−68.5)/3.1 for LI ranging from 86 to 101, and
EP≤(LI−81.1)/1.4 for LI ranging from 102 to 116,
LI being a load index of the tire.

26. The tire according to claim 16, further comprising:
a carcass reinforcement comprising at least one carcass layer anchored in the or each bead and extending radially in the or each sidewall and axially in the crown block radially to the inside of the crown reinforcement; and
an inner-liner layer bearing an interior surface of the tire,
the sidewall insert being arranged axially between the inner-liner layer and an axially innermost carcass layer.

27. The tire according to claim 26, wherein the carcass reinforcement comprises a single carcass layer anchored in the or each bead and extending radially in the or each sidewall and axially in the crown block radially to an inside of the crown reinforcement.

28. The tire according to claim 26, wherein the carcass reinforcement comprises first and second carcass layers anchored in the or each bead and extending radially in the or each sidewall and axially in the crown block radially to the inside of the crown reinforcement, the sidewall insert being arranged axially to an inside of the first carcass layer.

29. The tire according to claim 16, wherein the crown reinforcement comprises a working reinforcement comprising at least one working layer and one hoop reinforcement comprising at least one hooping layer, the at least one hoop reinforcement being arranged radially to an outside of the working reinforcement, the at least one hooping layer comprising, in the central part of the crown reinforcement, at least one corrugation.

30. The tire according to claim 29, wherein the at least one working layer comprises at least one corrugation.
